(19) United States
(12) Patent Application Publication
(10) Pub. No.: US 2012/0044952 A1
(43) Pub. Date: Feb. 23, 2012

(54) CONTROL DEVICE, NETWORK SYSTEM, TRANSMITTING DEVICE, RECEIVING DEVICE, CONTROL METHOD AND CONTROL PROGRAM

(75) Inventor: Kinya Ono, Kanagawa (JP)

(73) Assignee: PIONEER CORPORATION, Kanagawa (JP)

(21) Appl. No.: 13/266,363

(22) PCT Filed: Apr. 28, 2009
(86) PCT No.: PCT/JP2009/058406

§ 371 Date: Oct. 26, 2011

(51) Int. Cl. H04L 12/66

(52) U.S. Cl. 370/463

(57) ABSTRACT

The control device is a system controller that controls a connection in a network system, which establishes a connection, by connecting by a channel corresponding to a frequency band, between a logical output plug of a transmitting device and a logical input plug connected to the transmitting device via a bus. The control device includes a channel setting unit. The channel setting unit sets non-overlapping channels to the output plugs of all the transmitting devices in the network system.

### TECHNICAL FIELD

The present invention relates to a method of recovering a connection after a bus reset.

### BACKGROUND TECHNIQUE

IEEE1394 is known as a high speed serial digital interface which transfers real-time data, such as video and audio, isochronously and transfers control data asynchronously. FIG. 1 shows an outline of IEEE1394 associated standards. In order to perform isochronous transfer by IEEE1394, it is necessary to establish a logical connection between a transmitting device and a receiving device of video and audio, and it is known as CMP (Connection Management Procedure) in IEC61883-1 as shown in FIG. 2.

The connection establishment is realized by an device therefor, which retains a channel being an isochronous resource from IRM (Isochronous Resource Manager) uniquely existing on the IEEE1394 bus and a necessary frequency band, and associates, by channel information, a logical output plug of the transmitting device with a logical input plug of the receiving device, by using the transaction of IEEE1394. It is defined that, when a bus reset occurs, the device which has established the connection recovers the connection existed before the bus reset within one second from the bus reset.

For the transmission protocol of IEEE1394, at present, MPEG-2-TS, BT.601 is defined as video and A&M is defined as audio.

The control command specification on IEEE1394 is standardized by 1394TA (Trade Association), and the framework of AV/C command and the AV/C unit/sub-unit model are defined in “AV/C Digital Interface Command Set General Specification Version 4.2”. The AV/C sub unit is a functional unit existing inside the AV/C unit, and plural AV/C sub units may exist in one AV/C unit.

A serial bus isochronous output plug and a serial bus isochronous input plug of the AV/C unit correspond to the output plug and the input plug mentioned above. Also, a source plug and a destination plug of the AV/C sub unit correspond to the logical output plug and the logical input plug of the AV/C unit.

Also, CCM (AV/C Connection and Compatibility Management Specification 1.0) is defined to establish the ICE61883-1 connection on the receiving device side by using AV/C command.

When the above-mentioned video and audio are transmitted, it is necessary to establish a connection between the transmitting device and the receiving device. For example, as an example of a car AV system, it is assumed a system which includes a front monitor (F-monitor), a DVD player, an amplifier, a TV receiver and a rear monitor (R-monitor) and in which those devices are connected by a bus in a manner of daisy chain connection. In such a car AV system, when the DVD is watched by the F-monitor, the connection for transmitting the video signal from the DVD player to the F-monitor is established, and the connection for transmitting the audio signal from the DVD player to the amplifier is established. Here, when the TV broadcasting is further watched by the R-monitor, for example, the connection for transmitting the video signal and the audio signal from the TV receiver to the R-monitor is established. At this time, the video signal transmitted from the DVD player to the F-monitor, the audio signal transmitted from the DVD player to the amplifier, and the video signal and the audio signal transmitted from the TV receiver to the R-monitor are assigned with different channels, respectively.

In this state, if the accessory power supply (ACC) of the vehicle is once turned OFF and then turned ON, the bus temporarily becomes the divided state because each device of the car AV system requires a different time to be turned ON and activated. Therefore, there is a possibility that the channel is assigned to the above-mentioned video and audio signals redundantly. In such a case, when all devices of the car AV system are powered ON, the transmitting devices transmit different video or audio signals via the same channel for one second after the bus reset, and the video and/or audio cannot be normally reproduced by the receiving device such as the F-monitor and the R-monitor even when one second passes after the bus reset.

There is known a method of storing the reserve information (the reserve ID and the reserve time) and the communication resource (the channel and the frequency band) in correspondence with each other and performing the reservation management of the connections based on the information (Patent Reference-1). However, Patent Reference-1 does not assume the situation that the bus is divided, and its problem is different from that of the present invention.

### Patent Reference-1

Japanese Patent Application Laid-open under No. 10-327173

### DISCLOSURE OF INVENTION

### Problem to be Solved by the Invention

The above is one of the problem to be solved by the present invention. It is an object of the present invention to provide a control device capable of preventing the contention of the channels in plural connection establishing processes over plural devices.

### Means for Solving the Problem

The invention of claim 1 is a control device in a network system which establishes a connection, by connecting by a channel corresponding to a frequency band, between a logical output plug of a transmitting device and a logical input plug connected to the transmitting device via a bus, the control device including: a channel setting unit which sets non-overlapping channels to the output plugs of all the transmitting devices in the network system.

The invention of claim 8 is a transmitting device in a network system which establishes a connection, by connecting by a channel corresponding to a frequency band, between a logical output plug of a transmitting device and a logical input plug connected to the transmitting device via a bus, the transmitting device including: a non-volatile storage unit which stores channel information indicating non-overlapping channels in the network system; and a channel setting unit which sets the channels to the output plugs based on the channel information stored in the storage unit at a time of an activation.

The invention of claim 9 is a receiving device in a network system which establishes a connection, by connecting by a channel corresponding to a frequency band, between a logical output plug of a transmitting device and a logical input plug connected to the transmitting device via a bus, the receiving device including: a communicating unit which performs a communication with a transmitting device in the network system, in which non-overlapping channels are set to the output plugs; and a connection establishing unit which establishes a connection with the transmitting device by using the channel set to the output plug.

The invention of claim 10 is a receiving device in a network system which establishes a connection, by connecting by a channel corresponding to a frequency band, between a logical output plug of a transmitting device and a logical input plug connected to the transmitting device via a bus, the receiving device including: a non-volatile storage unit which stores channel assignment information in which non-overlapping channels are assigned to all the output plugs in the network system.

The invention of claim 11 includes a connection establishing unit which determines a channel of the output plug of the transmitting device subjected to the connection based on the channel assignment information, and establishes the connection with the transmitting device by using the channel.

The invention of claim 12 is a receiving device in a network system which establishes a connection, by connecting by a channel corresponding to a frequency band, between a logical output plug of a transmitting device and a logical input plug connected to the transmitting device via a bus, the receiving device including: a command receiving unit which receives a connection establishment execution request command to which channel information indicating non-overlapping channels in the network system is added; and a connection establishing unit which establishes the connection with the transmitting device based on the channel information added to the connection establishment execution request command.

The invention of claim 13 is a network system which establishes a connection, by connecting by a channel corresponding to a frequency band, between a logical output plug of a transmitting device and a logical input plug connected to the transmitting device via a bus, including: a channel setting unit which sets non-overlapping channels to the output plugs of all the transmitting devices connected to the bus.

The invention of claim 14 is a control method executed by a control device in a network system which establishes a connection, by connecting by a channel corresponding to a frequency band, between a logical output plug of a transmitting device and a logical input plug connected to the transmitting device via a bus, the control method including: a channel setting process which sets non-overlapping channels to the output plugs of all the transmitting devices in the network system.

The invention of claim 15 is a control program executed by a computer in a network system which establishes a connection, by connecting by a channel corresponding to a frequency band, between a logical output plug of a transmitting device and a logical input plug connected to the transmitting device via a bus, the control program makes the computer function as: a channel setting unit which sets non-overlapping channels to the output plugs of all the transmitting devices in the network system.

### BRIEF DESCRIPTION OF THE DRAWINGS

FIG. 1 is a diagram showing an outline of IEEE1394 associated standard.

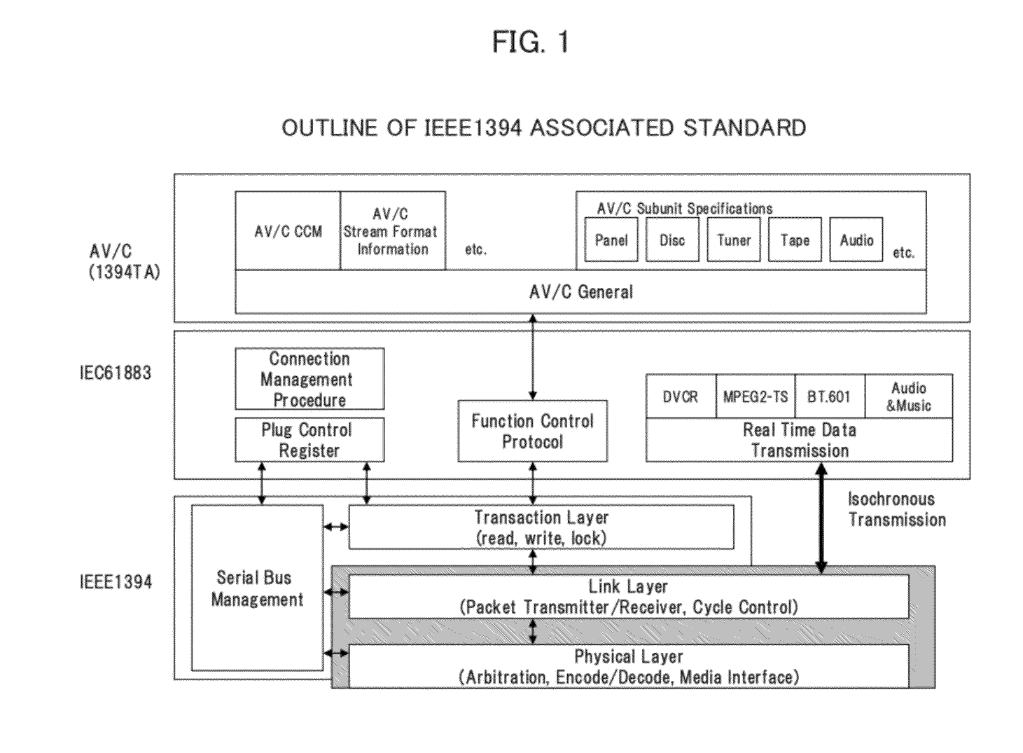

FIG. 2 is a diagram showing a configuration of CMP of IEC61883-1.

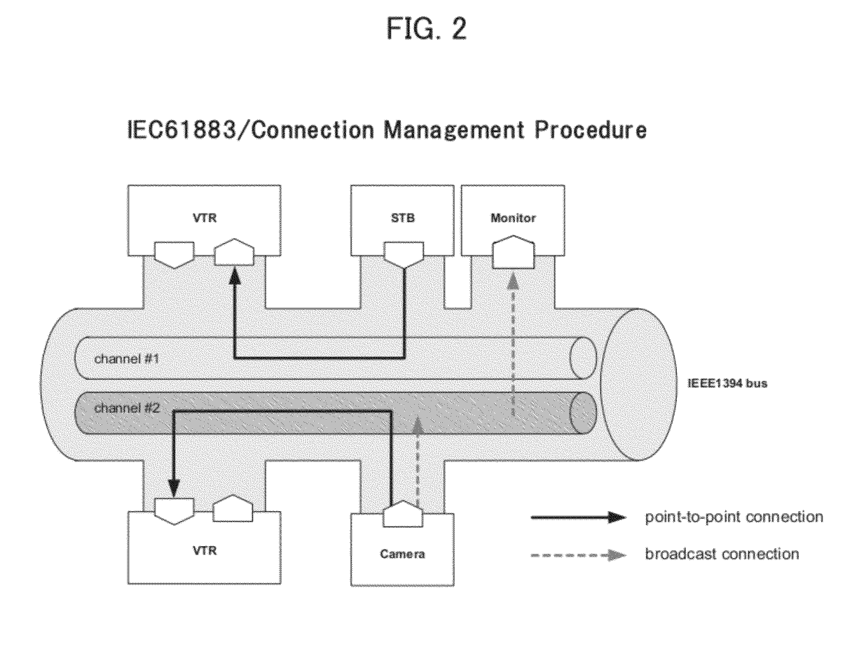

FIG. 3 is a diagram showing an example of a configuration of a car AV system according to an embodiment.

FIGS. 4A and 4B are diagrams each showing an example of operation of the car AV system according to the embodiment.

FIGS. 5A and 5B are diagrams each showing an example of operation of the car AV system according to the embodiment.

FIG. 6 is a diagram showing an example of equipment recognition information.

FIG. 7 is a diagram showing an example of channel assignment information.

FIG. 8 is a diagram showing a configuration example of a car AV system according to the embodiment.

FIG. 9 is a flowchart of a channel assignment information generation process.

FIG. 10 is a flowchart of a channel assignment information generation process.

FIG. 11 is a diagram showing a channel assignment information setting command format.

FIG. 12 is a diagram showing a format of an output plug of IEC61833-1.

FIG. 13 is a diagram showing an example of a configuration of a transmitting device.

FIG. 14 is a flowchart of a connection establishment process.

FIG. 15 is a diagram showing a relation between a system controller, a transmitting device and a receiving device.

FIG. 16 is a diagram showing a relation between a system controller, a transmitting device and a receiving device.

FIG. 17 is a diagram showing an example of a configuration of a receiving device.

FIG. 18 is a flowchart of a connection establishment process.

FIG. 19 is a diagram showing an example of a configuration of a system controller.

FIG. 20 is a diagram showing a format of an expanded INPUT SELECT command.

FIG. 21 is a flowchart of a connection establishment process.

### DESCRIPTION OF REFERENCE NUMBERS

1 Car AV System

10 Bus

11 Front Monitor

12 DVD Player (System controller)

13 Amplifier

14 Car Navigation Device

15, 16 Rear Monitor (System controller)

### MOST PREFERRED FORM TO EXERCISE THE INVENTION

According to one aspect of the present invention, there is provided a control device in a network system which establishes a connection, by connecting by a channel corresponding to a frequency band, between a logical output plug of a transmitting device and a logical input plug connected to the transmitting device via a bus, the control device including: a channel setting unit which sets non-overlapping channels to the output plugs of all the transmitting devices in the network system.

The above control device is a system controller that controls a connection in a network system, which establishes a connection, by connecting by a channel corresponding to a frequency band, between a logical output plug of a transmitting device and a logical input plug connected to the transmitting device via a bus. The control device includes a channel setting unit. The channel setting unit sets non-overlapping channels to the output plugs of all the transmitting devices in the network system. By this, the contention occurring at the time of establishing the connection can be avoided.

One mode of the above control device include: an output plug detecting unit which detects the output plugs of all the transmitting devices connected to the bus, after a bus reset; and a channel assignment information generating unit which generates channel assignment information in which the non-overlapping channels are assigned to all the output plugs detected by the output plug detecting unit. By this, it is possible to flexibly cope with the change of the system configuration.

Another mode of the above control device includes a non-volatile storage unit which stores the channel assignment information generated by the channel assignment information generating unit. By this, in the case where the power supply of the control device is once turned OFF and then is turned ON again, the connection can be established without the channel contention.

Still another mode of the above control device includes a channel assignment information notifying unit which transmits the channel assignment information to other control device in the network system. By this, the channel assignment information can be commonly owned, and new channel assignment information can be generated by the other control device by using the existing channel assignment information.

Still another mode of the above control device includes: a channel information obtaining unit which obtains the channel information of the output plug of the transmitting device based on the channel assignment information; and a channel information notifying unit which transmits the channel information obtained by the channel information obtaining unit to the transmitting device. By this, the transmitting device can retain the channel of the output plug which does not overlap with other transmitting device.

Still another mode of the above control device includes a channel assignment information notifying unit which transmits the channel assignment information to the receiving device. By this, the receiving device can retain the channel assignment information, and can establish the connection with the transmitting device without the overlap of the channel.

Still another mode of the above control device includes a channel information deleting unit which deletes the channel information of the output plug of the transmitting device, which is not connected to the bus, from the channel assignment information, if a number of the channel information of the channel assignment information exceeds an retainable upper limit or if a predetermined time has passed after the bus reset. By this, the channel information of the transmitting devices connected to the bus can be included in the channel assignment information as many as possible.

According to another aspect of the present invention, there is provided a transmitting device in a network system which establishes a connection, by connecting by a channel corresponding to a frequency band, between a logical output plug of a transmitting device and a logical input plug connected to the transmitting device via a bus, the transmitting device including: a non-volatile storage unit which stores channel information indicating non-overlapping channels in the network system; and a channel setting unit which sets the channels to the output plugs based on the channel information stored in the storage unit at a time of an activation. By this transmitting device, the device which executes the connection process can establish the connection by using the non-overlapping channel in the network system, without the need of waiting for the activation of all the devices in the network system, if the partner of the connection exists on the same bus when the ACC power supply is turned ON.

According to still another aspect of the present invention, there is provided a receiving device in a network system which establishes a connection, by connecting by a channel corresponding to a frequency band, between a logical output plug of a transmitting device and a logical input plug connected to the transmitting device via a bus, the receiving device including: a communicating unit which performs a communication with a transmitting device in the network system, in which non-overlapping channels are set to the output plugs; and a connection establishing unit which establishes a connection with the transmitting device by using the channel set to the output plug. By this receiving device, it is possible to establish the connection by using the non-overlapping channel in the network system, without the need of waiting for the activation of all the devices in the network system, if the partner of the connection exists on the same bus when the ACC power supply is turned ON.

According to still another aspect of the present invention, there is provided a receiving device in a network system which establishes a connection, by connecting by a channel corresponding to a frequency band, between a logical output plug of a transmitting device and a logical input plug connected to the transmitting device via a bus, the receiving device including: a non-volatile storage unit which stores channel assignment information in which non-overlapping channels are assigned to all the output plugs in the network system. Also by this receiving device, it is possible to establish the connection by using the non-overlapping channel in the network system, without the need of waiting for the activation of all the devices in the network system, if the partner of the connection exists on the same bus when the ACC power supply is turned ON.

A preferred embodiment of the above receiving device includes a connection establishing unit which determines a channel of the output plug of the transmitting device subjected to the connection based on the channel assignment information, and establishes the connection with the transmitting device by using the channel.

According to still another aspect of the present invention, there is provided a receiving device in a network system which establishes a connection, by connecting by a channel corresponding to a frequency band, between a logical output plug of a transmitting device and a logical input plug connected to the transmitting device via a bus, the receiving device including: a command receiving unit which receives a connection establishment execution request command to which channel information indicating non-overlapping channels in the network system is added; and a connection establishing unit which establishes the connection with the transmitting device based on the channel information added to the connection establishment execution request command. Also by this receiving device, it is possible to establish the connection by using the non-overlapping channel in the network system, without the need of waiting for the activation of all the devices in the network system, if the partner of the connection exists on the same bus when the ACC power supply is turned ON.

According to still another aspect of the present invention, there is provided a network system which establishes a connection, by connecting by a channel corresponding to a frequency band, between a logical output plug of a transmitting device and a logical input plug connected to the transmitting device via a bus, including: a channel setting unit which sets non-overlapping channels to the output plugs of all the transmitting devices connected to the bus. Also by this network system, the contention of the channels can be avoided at the time of establishing the connection.

According to still another aspect of the present invention, there is provided a control method executed by a control device in a network system which establishes a connection, by connecting by a channel corresponding to a frequency band, between a logical output plug of a transmitting device and a logical input plug connected to the transmitting device via a bus, the control method including: a channel setting process which sets non-overlapping channels to the output plugs of all the transmitting devices in the network system. Also by this method, the contention of the channels can be avoided at the time of establishing the connection.

According to still another aspect of the present invention, there is provided a control program executed by a computer in a network system which establishes a connection, by connecting by a channel corresponding to a frequency band, between a logical output plug of a transmitting device and a logical input plug connected to the transmitting device via a bus, the control program makes the computer function as: a channel setting unit which sets non-overlapping channels to the output plugs of all the transmitting devices in the network system. Also by this program, the contention of the channels can be avoided at the time of establishing the connection.

### Embodiment

A preferred embodiment of the present invention will be described below with reference to the attached drawings.

[Car AV System]

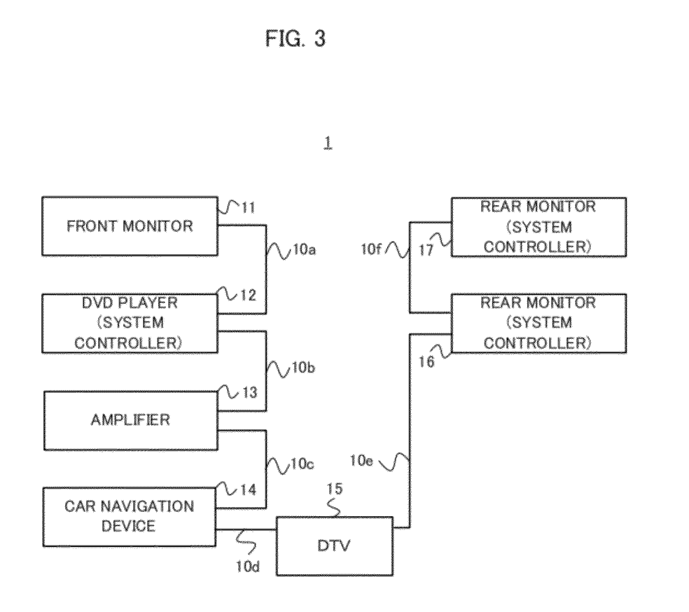

First, a configuration and prerequisites of a car AV (Audio Video) system 1 will be described with reference to FIG. 3. FIG. 3 is a diagram showing an example of a configuration of a car AV system 1 according to an embodiment of the present invention.

As shown in FIG. 3, the car AV system 1 includes a front monitor (hereinafter referred to as “F-monitor”) 11, a DVD player 12, an amplifier 13, a car navigation device 14, a DTV (Digital TeleVison) 15, and rear monitors (hereinafter referred to as “R-monitor) 16, 17, which are connected in the daisy chain manner by the cables 10a to 10f for the IEEE1394 bus. In the following description, the cables 10a to 10f will be simply referred to as “bus 10” if they are referred to together.

The F-monitor 11 is a video receiving device which displays video on a display based on various video signals received from a video transmitting device. The F-monitor 11 includes a graphic controller which performs the control of the F-monitor 11 based on the control signal transmitted from the controller or the transmitting device via the system bus 10, and a memory such as a VRAM (Video RAM). Also, the F-monitor 11 includes a buffer memory which temporarily stores the video signal promptly displayable, a display control unit which controls the display such as an LCD and a CRT (Cathode Ray Tube) based on the video signal outputted by the graphic system controller, and a display. The display may be a liquid crystal display device of 5 to 10 inches, mounted near the front panel in the vehicle compartment.

The DVD player 12 is a video transmitting device which reads out contents data such as an audio signal and a video signal from a disc such as DVD and transmits them to the video receiving device. The DVD player 12 is also an audio transmitting device which transmits data to an audio receiving device.

The amplifier 13 is connected to the on-vehicle speakers 18, and is an audio receiving device which outputs audio via the on-vehicle speakers 18 based on the various audio signals received from the audio transmitting device. The amplifier 13 includes a D/A (Digital to Analog) converter which performs the A/D conversion of the audio signal received via the bus 10, and an amplifier which amplifies the audio analog signal outputted from the D/A converter.

The car navigation device 14 utilizes a GPS and stand-alone measurement devices such as vehicle speed pulses and a gyro-sensor, and performs a guidance such as a presentation of a current position and a route guidance to a destination for the user during the driving of the vehicle. The car navigation device 14 is an audio transmitting device, which retains guide voice necessary for the guidance and reads out the corresponding audio signal to transmit it to the audio receiving device. Also, the car navigation device 14 is a video transmitting device, which retains map data necessary for the guidance and reads out the corresponding video signal to transmit it to the video receiving device.

The DTV 15 is an device which receives a television broadcasting using a digital modulation and a digital compression (e.g., the terrestrial digital broadcasting in Japan). In the car AV system 1, the DTV 15 is an audio transmitting device which transmits the audio signal of the received television broadcasting to the audio receiving device. Also, the DTV 15 is a video transmitting device which transmits the video signal of the received television broadcasting to the video receiving device.

R-monitors 16 and 17 are the video receiving devices like the F-monitor 11, but are mounted on the rear area of the vehicle compartment. Also, the R-monitors 16 and 17 function as the audio receiving device like the amplifier 13.

In this embodiment, the F-monitor 11, the DVD player 12 and the R-monitors 16 and 17 have a HMI (Human Machine Interface) such as a touch-panel and buttons, and function as a system controller to control the car AV system 1. The system controller basically exists in the monitors and a H/U (Head Unit). While the system controllers are the DVD player 12 and the R-monitor 16 in this embodiment, the present invention is not limited to this. The device which functions as a controller may be arbitrarily set.

Each system controller can operate independently, and performs the recognition of the devices on the network (bus 10) and the connection management of the device subjected to the operation of the system controller itself. On the network, there are plural system controllers which establish the connection between the devices.

Here, the receiving device subjected to the management by each system controller is determined. For example, the receiving devices subjected to the management by the system controller of the DVD player 12 are the F-monitor 11 and the amplifier 13. The receiving device subjected to the management by the system controller of the R-monitor 16 is the R-monitor 16 itself. Each system controller performs the equipment recognition process, and manages the control and management of the connection between the receiving device subjected to its management and the transmitting device, as well as the selected source information. Here, the selected source information is source type information of the video and audio currently being selected (the terrestrial digital broadcasting, the DVD, the AM/FM tuner, etc.), and the watching and listening environment is recovered based on the selected source information when the accessory power supply (ACC) of the system is activated next time. Also, each system controller controls the connection between the devices in accordance with the instruction from the application such as the UI (user interface) of the monitor and H/U.

Each process by the system controller, the transmitting device and the receiving device described in this embodiment is realized by each CPU of the system controller, the transmitting device and the receiving device which execute the program prepared in advance.

[Operation Example of Car AV System]

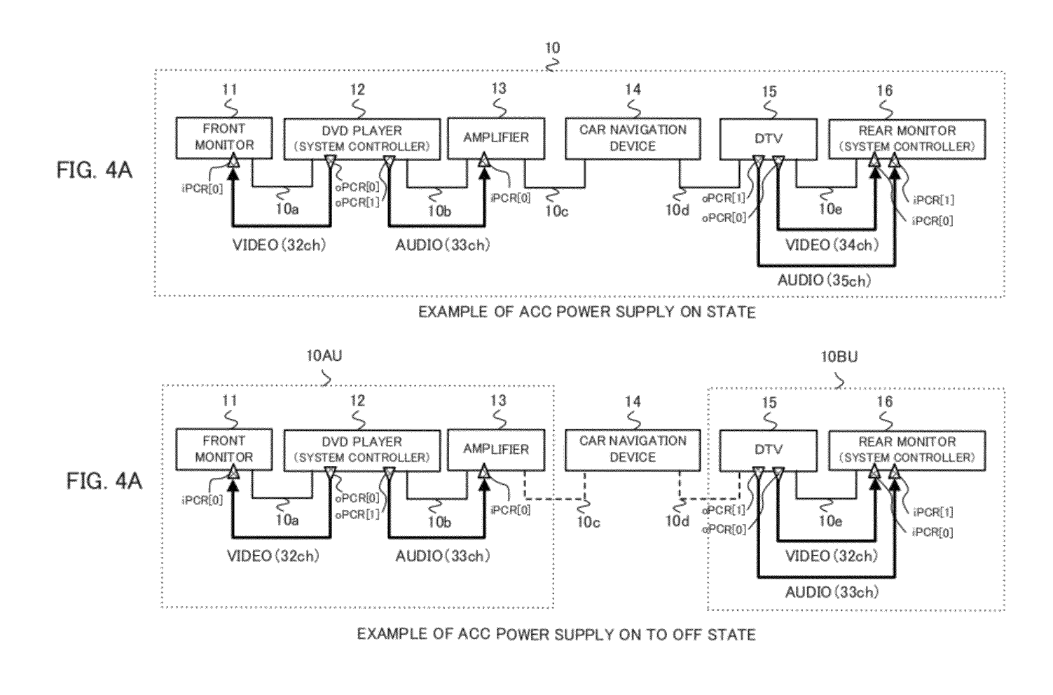

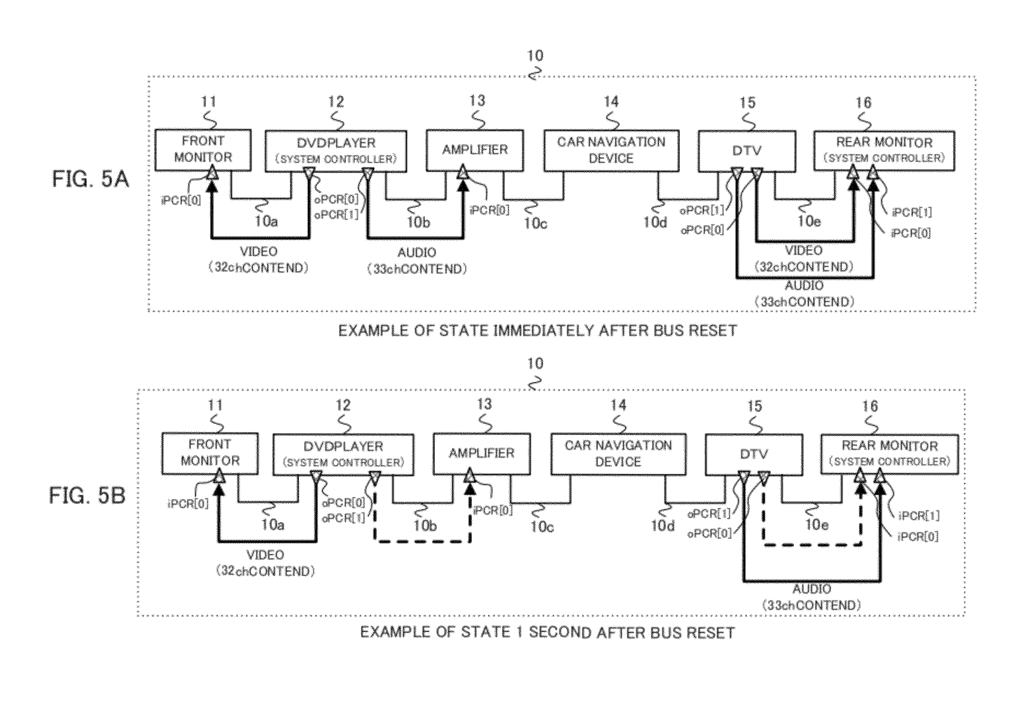

Next, the operation example of the car AV system 1 will be concretely described with reference to FIGS. 4 and 5. FIGS, 4 and 5 are schematic diagrams illustrating an example of the operation state of the car AV system 1 when the ACC power supply of the vehicle is once turned OFF and then is tuned ON again.

Concretely, FIG. 4A illustrates the operation state when the accessory (ACC) power supply is ON, and FIG. 4B illustrates the operation state immediately after the ACC power supply is once turned OFF and then is turned ON again. FIG. 5A illustrates the operation state immediately after all the devices connected to the bus 10 are activated and the bus reset occurs, and FIG. 5B illustrates the operation state when one second has passed after the bus reset occurs. In FIGS. 4A, 4B, 5A and 5B, oPCR (output Plug Control Register) indicates the logical output plug, and iPCR (input Plug Control Register) indicates the logical input plug. If one device has plural plugs, a plug ID is added to discriminate each plug in the device. For example, if one transmitting device has two output plugs, the output plugs are expressed as oPCR[0], oPCR[1]. Here, “0”, “1” in the brackets correspond to the plug ID.

When the DVD is watched by the F-monitor 11, the system controller of the DVD player 12 selects the DVD player 12 as the video transmitting device, selects the F-monitor 11 as the video receiving device, selects the DVD player 12 as the audio transmitting device and selects the amplifier 13 as the audio receiving device. The system controller of the DVD player 12 transmits the connection establishment request to the device (e.g., each receiving device) for executing the connection process, and establishes the connection to transmit the video signal from the video transmitting device to the video receiving device and the connection to transmit the audio signal from the audio transmitting device to the audio receiving device.

Here, if the TV is watched by the R-monitor 16, the system controller of the R-monitor 16 selects the DTV 15 as the video transmitting device and the audio transmitting device, and selects the R-monitor 16 as the video receiving device and the audio receiving device. Similarly to the DVD player 12, the system controller of the R-monitor 16 transmits the connection establishment request to the device (e.g., each receiving device) for executing the connection process, and establishes the connection to transmit the video signal from the video transmitting device to the video receiving device and the connection to transmit the audio signal from the audio transmitting device to the audio receiving device.

At this time, the device which executes the connection process retains the channels (0-63ch) being the isochronous resource and the necessary frequency band from the IRM uniquely existing on the bus 10, and establishes the connection between the output plug of the transmitting device and the input plug of the receiving device by using the retained channel. The channel is associated with the frequency band, and the frequency band depends on the data rate of the video and/or audio signal outputted by the transmitting device.

For example, as shown in FIG. 4A, the F-monitor 11 establishes the connection between the output plug oPCR[0] of the DVD player 12 being the video transmitting device and the input plug iPCR[0] of the F-monitor 11 being the video receiving device by the channel 32ch. The amplifier 13 establishes the connection between the output plug oPCR[1] of the DVD player 12 being the audio transmitting device and the input plug iPCR[0] of the amplifier 13 being the audio receiving device by the channel 33ch.

The R-monitor 16 establishes the connection between the output plug oPCR[0] of the DTV 15 being the video transmitting device and the input plug iPCR[0] of the R-monitor 16 being the video receiving device by the channel 34ch. The R-monitor 16 establishes the connection between the output plug oPCR[1] of the DTV 15 being the audio transmitting device and the input plug iPCR[1] of the R-monitor 16 being the audio receiving device by the channel 35ch.

Namely, in the operation state shown in FIG. 4A, the device which executes the connection process retains the channels and the necessary frequency bands from the IRM uniquely existing on the bus 10, and therefore the connections between the devices are established by the non-overlapping, different channels.

Here, in the car AV system, the state of the ACC power supply of the vehicle is detected, and each of the receiving devices retains the selected source information even when the ACC power supply is turned OFF and the power supply to the car AV system 1 is cut off. This is because, as described above, it is necessary to recover the video and audio watched and listened before the ACC power supply is turned OFF as soon as possible, when the ACC power supply is tuned ON and the power supply to the car AV system 1 is restarted.

However, if the ACC power supply is tuned ON and the power supply to the car AV system 1 is restarted, each of the devices requires different time for its activation. For example, in the operation state shown in FIG. 4B, immediately after the ACC power supply is tuned ON, the activation of the car navigation device 14 is delayed and other devices have been activated. Since each of the devices are connected by the daisy chain manner in the car AV system 1, if the activation of the car navigation device 14 is delayed, the signal is not transmitted via the car navigation device 14 and the bus 10 becomes the state of being divided into the bus 10AU and 10BU as shown in FIG. 4B.

If a trial is made to recover the established connection or establish a new connection at this time, the channel and the frequency band are retained in the bus 10AU and 10BU, respectively, from the IRM connected to those buses, and therefore there is a possibility that overlapped channels are used in view of the car AV system 1 in its entirety.

For example, in the example shown in FIG. 4B, the IRM existing on the bus 10AU retains the channels and the frequency bands, and the connection between the video transmitting device (DVD player 12) and the video receiving device (F-monitor 11) is established by the channel 32ch and the connection between the audio transmitting device (DVD player 12) and the audio receiving device (amplifier 13) is established by the channel 33ch. On the other hand, the IRM existing on the bus 10BU retains the channels and the frequency bands, and the connection between the video transmitting device (DTV15) and the video receiving device (R-monitor 16) is established by the channel 32ch and the connection between the audio transmitting device (DTV 15) and the audio receiving device (R-monitor 16) is established by the channel 33ch. Namely, in the example shown in FIG. 4B, the channels transmitting the video signals and the audio signals are overlapped, respectively, in view of the entire car AV system.

If the car navigation device 14 is activated thereafter as shown in FIG. 5A, the bus 10AU and 10BU are integrated to be the single bus 10. At this time, the bus reset occurs by the activation of the car navigation device 14. During one second after the bus reset, the process of recovering the connections existed before the bus reset is performed in each of the devices in which the connection was established according to IEC61883-1. During this connection recovery process, the video signals and the audio signals are transmitted via the channels that were used before the bus reset. Therefore, the video signals and the audio signals are transmitted in such a manner that the channels are overlapped and contending. In this case, there is a possibility that different video or audio signals are transmitted from plural sources via the same channel, and the video or audio falls in the transmission failure and cannot be normally reproduced.

Further, this state continues and one second passes after the bus reset, the recovery of one of the connections using the contending channels fails as shown in FIG. 5B. For example, in the example shown in FIG. 5B, out of the two connections using the channel 32ch, the recovery of the connection for transmitting the video signal between the DTV 15 and the R-monitor 16 becomes failed. Also, out of the two connections using the channel 33ch, the recovery of the connection for transmitting the audio signal between the DVD player 12 and the amplifier 13 becomes failed. Thus, if the connection recovery process is executed in the state that the channels are in contention, there is a possibility that the previous state of the sources at the time when the ACC power supply was ON cannot be recovered. In addition, if the connections are recovered based on the channels used before the bus reset, each of the receiving devices may establish the connection with wrong transmitting device.

Therefore, in this embodiment, non-overlapping channels are assigned to the output plugs of all the transmitting devices in the car AV system 1. Concretely, out of the system controllers in the car AV system 1, a representative system controller generates channel assignment information by which non-overlapping channels are assigned to the output plugs of all the transmitting devices in the car AV system 1. Then, the device which executes the connection process obtains the channel assigned to the output plug of the transmitting device subjected to the connection process based on the channel assignment information, and established the connection by using the channel thus obtained. This will be described concretely below.

[Generating Method of Channel Assignment Information]

First, the generating method of channel assignment information will be described.

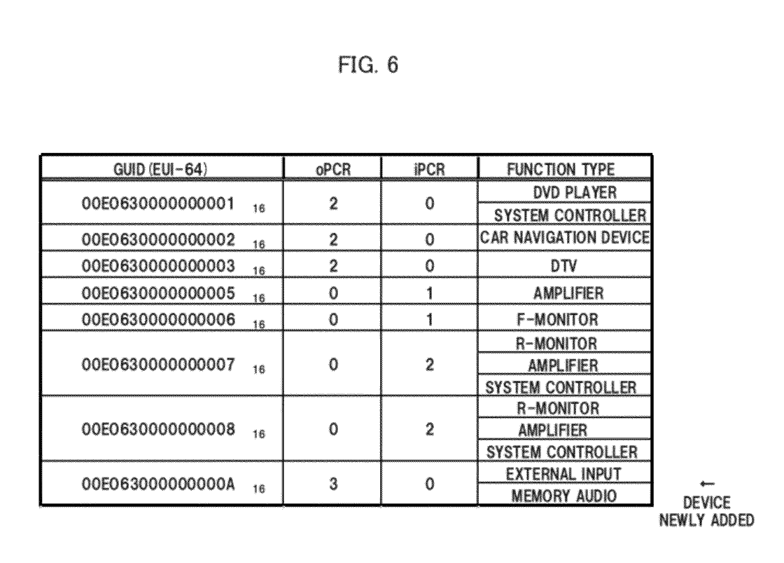

First, after the bus reset occurs, each of the system controllers in the car AV system 1 executes the equipment recognition process of each device connected to the bus 10, and generates the equipment recognition information. An example of the equipment recognition information is shown in FIG. 6. The equipment recognition information includes at least equipment's own IDs and plug information (plug type, number of plugs). Each of the system controllers stores the equipment recognition information into a non-volatile memory after generating it.

In FIG. 6, “GUID” indicates the equipment's own ID, “oPCR” indicates the number of the output plugs, and “iPCR” indicates the number of the input plugs. “GUID” is an identifier of 64 bits which is retained in a register space called Configuration ROM in an equipment (node) having IEEE1394 and is assigned to each of a product. The equipment's own ID is an ID always unique in the system, and is not necessarily “GUID” if it can identify each equipment. According to the equipment recognition information, it is understood that the DVD player 12 and the car navigation device 14 have two output plugs, respectively. Also, it is understood that the amplifier 13 and the F-monitor 11 has one input plug, respectively, and the R-monitor 16, 17 have two input plugs, respectively. Further, according to the equipment recognition information shown in FIG. 6, it is understood that a memory audio is newly connected to the bus 10 via an external input, and the external input has three output plugs. The equipment recognition information may further include specific information of function, format information of video or audio, and information of physical connection state to the bus 10.

Out of the system controllers in the car AV system 1, the representative system controller generates the equipment recognition information, and then generates the channel assignment information indicating the assignment of channels to the output plugs of all the transmitting devices based on the equipment recognition information. Here, the representative system controller is the system controller having a maximum or minimum PhyID (ID specifying the device) on the bus 10, for example. Also, the system controller existing in the H/U may constantly function as the representative system controller. “PhyID” is a physical ID which is assigned to each node after the bus reset in IEEE1394 and changes every time the bus reset occurs.

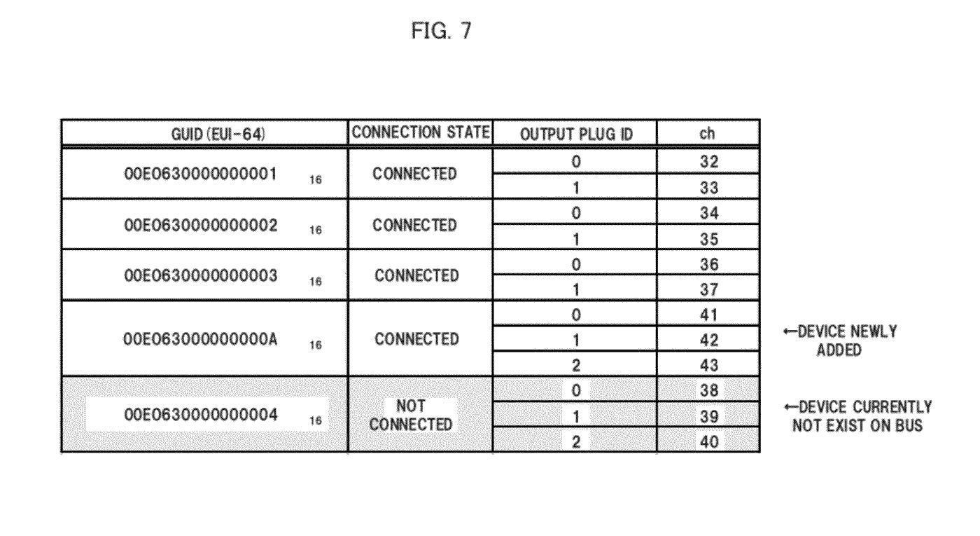

The representative system controller generates the channel assignment information based on the equipment recognition information, by assigning the channels to the output plugs of all the transmitting devices connected to the bus 10 in a non-overlapping manner. An example of the channel assignment information is shown in FIG. 7. The channel assignment information indicates the channel to be used at the time of establishing the connection for the output plug of each of the transmitting devices of the whole system, and includes at least the equipment's own ID (GUID), the plug ID of the output plug and the channel (ch) assigned to the output plug. In FIG. 7, “connection state” indicates the physical connection state to the bus 10.

The timing of generating the channel assignment information may be the timing after the end of generating the equipment recognition information after the bus reset, or the representative system controller may automatically detect that all the devices in the system are recognized. Instead, it may be started by a user operation when the user refers to the equipment recognition information via UI and all the equipment on the system are recognized.

According to the channel assignment information shown in FIG. 7, out of the two output plugs of the DVD player 12, the channel 32ch is assigned to the output plug oPCR[0] and the channel 33ch is assigned to the output plug oPCR[1]. Similarly, the channels 34ch, 35ch are assigned to the two output plugs of the car navigation device 14, and the channels 36ch, 37ch are assigned to the two output plugs of the DTV 15.

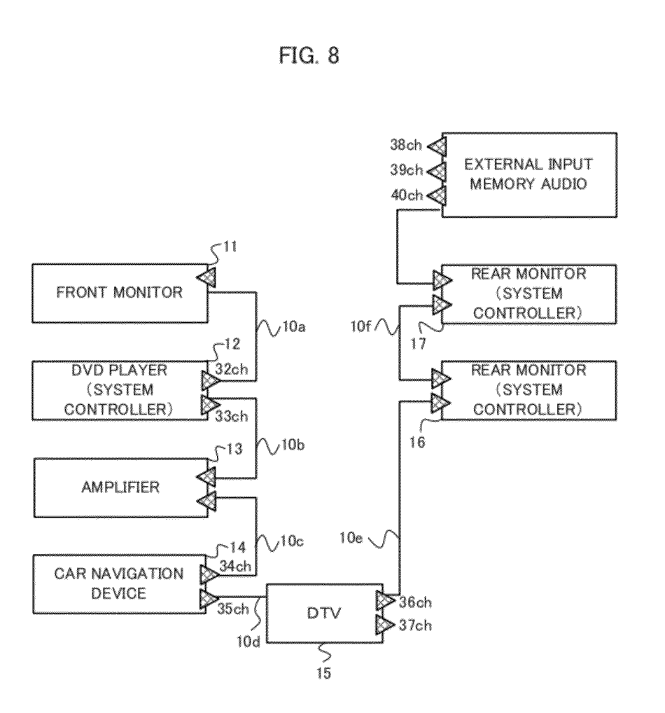

By referring to FIG. 7, it is understood that the channels 41ch to 43ch are assigned to the three output plugs of the external input which is newly added. This is because the channels 38ch to 40ch have been already assigned to the non-connected transmitting device which is not currently being connected to the bus 10. Namely, in the case where the representative system controller retains the existing channel assignment information previously generated, the representative system controller does not delete the channel already been assigned to the transmitting device and include it to the new channel assignment information for the transmitting device which has been registered in the existing channel assignment information but is not recognized by the equipment recognition processing of this time. FIG. 8 shows the configuration of the car AV system 1 based on the channel assignment information in which the channels are assigned in the above way.

Here, the description will be concretely given of the generating method of new channel assignment information in the case where the representative system controller retains the existing channel assignment information.

First, the description will be given of the generating method of the channel assignment information in the case where the new channel assignment information does not include information indicating the physical connection state.

In this case, the representative system controller extracts, after the bus reset, the equipment's own ID and the number of the output plugs of the transmitting device from the equipment recognition information, and copies the existing channel assignment information to the new channel assignment information. The representative system controller searches the transmitting device from new channel assignment information to which the existing channel assignment information is copied, by using the equipment's own ID of the transmitting device extracted from the equipment recognition information. If the transmitting device is already registered as the result of the search for the transmitting device, the representative system controller retains the channels already assigned to the output plug of the transmitting device. If the transmitting device is not registered, the representative system controller sets the channel, which does not overlap with the channel already been assigned, to the output plug of the transmitting device. When the channels are assigned to the output plugs of all the transmitting devices in the equipment recognition information, the generation of the new channel assignment information is completed.

Next, the generation method of the channel assignment information will be described in the case where the physical connection information is expressed by the structure in the new channel assignment information. The case where the physical connection information is expressed by the structure means the channel assignment information, as shown in FIG. 7, in which ones whose physical connection state is “connected” are arranged first and then ones whose physical connection state is “not connected” are arranged.

In this case, the representative system controller extracts, after the bus reset, the equipment's own ID and the number of the output plugs of the transmitting device from the equipment recognition information. The representative system controller adds all the transmitting devices in the equipment recognition information (i.e., connected to the bus 10), in order, from the top of the list of the new channel assignment information. At this time, the representative system controller searches the existing channel assignment information for the transmitting device to be added. As a result, when the transmitting device to be added is registered in the existing channel assignment information, the representative system controller registers the channel already assigned to the output plug to the new channel assignment information as the channel of the output plug of the transmitting device. On the contrary, when the transmitting device to be added is not registered in the existing channel assignment information, the representative system controller registers the channel, which does not overlap with the channel already assigned, to the new channel assignment information as the channel of the output plug of the transmitting device. After registering all the transmitting devices in the equipment recognition information to the new channel assignment information, the representative system controller copies the transmitting device, which exists in the existing channel assignment information but does not exist in the equipment recognition information (i.e., not connected to the bus 10), to the new channel assignment information, together with the channels assigned by the existing channel assignment information. Thus, generating the new channel assignment information is completed.

Next, the description will be given of the generating method of the channel assignment information in the case where the new channel assignment information includes information indicating the physical connection state but the physical connection state is not expressed by the structure.

In this case, the representative system controller extracts, after the bus reset, the equipment's own ID and the number of the output plugs of the transmitting device from the equipment recognition information, and copies the information, obtained by changing the “connection state” of the existing channel assignment information to “not connected”, to the new channel assignment information. The representative system controller searches the new channel assignment information, to which the existing channel assignment information is copied, for the transmitting device based on the equipment's own ID extracted from the equipment recognition information. If it is the device already registered as the result of the search for the transmitting device, the representative system controller retains the channel already assigned to the output plug, and changes the “connection state” to “connected”. On the contrary, if it is the device not registered, the representative system controller sets and registers the channel to the output plug so as not to overlap with the channel already assigned, and changes the “connection state” to “connected”. When the channels are assigned to the output plugs of all the transmitting devices in the equipment recognition information, generating the new channel assignment information is completed.

As is understood from the above description, in the generating method of the new channel assignment information, the representative system controller assigns the channel to the output plug of the transmitting device newly connected to the bus 10 so as not to overlap with the channels of the output plugs of all the transmitting devices existing in the existing channel assignment information. If the channel assignment information is newly generated, or if the new channel assignment information changes in comparison with the existing channel assignment information, or if an device to which the channel assignment information is to be notified newly appears after the bus reset, the representative system controller notifies the channel assignment information to the device to be notified (other system controller and/or the receiving device). This is done in order to commonly own the channel assignment information, or to enable the device for executing the connection process to refer to the channel assignment information.

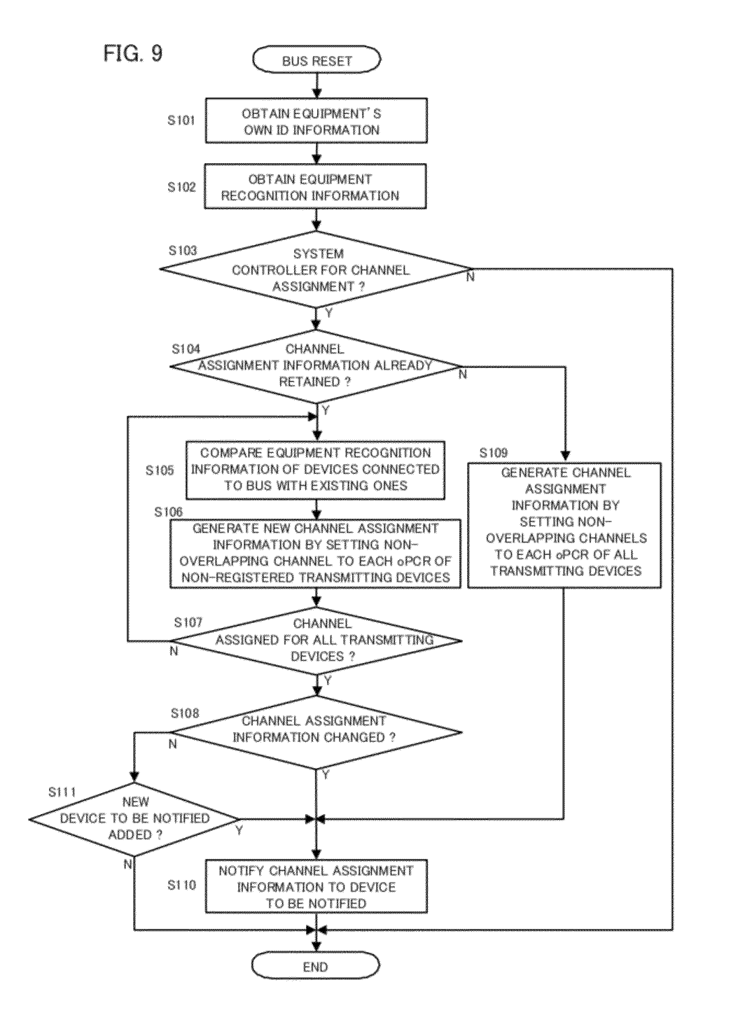

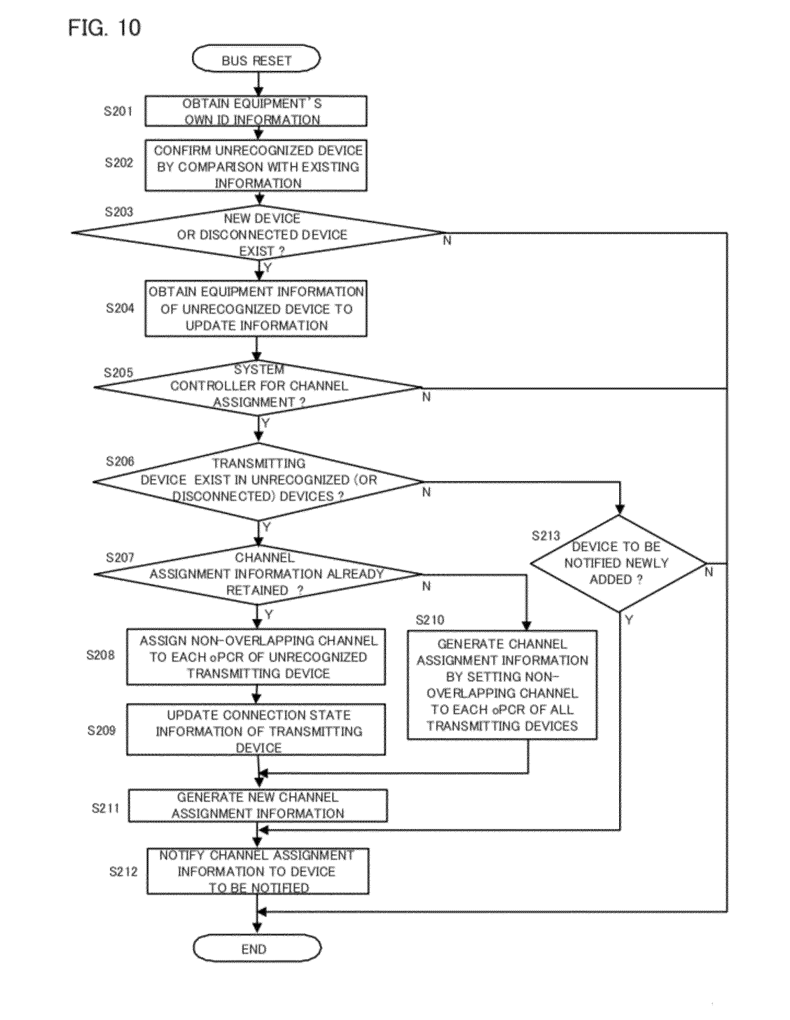

Next, the generation process of the channel assignment information will be described with reference to FIGS. 9 and 10.

First, by referring to FIG. 9, the description will be given of the channel assignment information generation process in a case where the system controller does not store the existing equipment recognition information.

First, in step S101, the system controller executes the process of obtaining the equipment's own ID of the device which is connected to the bas 10 after the bus reset. In the next step S102, the system controller obtains the equipment recognition information based on the obtained equipment's own ID. After that, the system controller goes to the process of step S103.

In step S103, if the system controller is the system controller that executes the channel assignment, i.e., the representative system controller (step S103: Yes), the process goes to step S104. If the system controller is not the representative system controller (step S103: No), the system controller stores the obtained equipment recognition information to the non-volatile memory and ends this control process.

In step S104, the system controller determines whether or not it already has the channel assignment information, i.e., whether or not it has the existing channel assignment information. If the system controller has the existing channel assignment information (step S104: Yes), it goes to step S105. On the contrary, if the system controller does not have the existing channel assignment information (step S104: No), it goes to step S109 to set non-overlapping channels to the output plugs of all the transmitting devices existing in the equipment recognition information to thereby generate the channel assignment information, and then goes to step S110.

In step S105, the system controller compares the equipment recognition information with the existing channel assignment information, and specifies the non-registered transmitting device, which is not included in the existing channel assignment information, from the transmitting devices existing in the equipment recognition information. In next step S106, the system controller set a non-overlapping channel to the output plug of the non-registered transmitting device, which is not included in the existing channel assignment information, to generate new channel assignment information. After that, the system controller goes to step S107.

In step S107, the system controller determines whether or not the channel assignment is completed for all the transmitting devices existing in the equipment recognition information. If the channel assignment is not completed (step S107: No), the system controller returns to step S105. If the channel assignment is completed (step S107: Yes), the system controller goes to step S108.

In step S108, the system controller compares the new channel assignment information with the existing channel assignment information to determine whether or not the generated new channel assignment information changes. The system controller goes to step S110 if the new channel assignment information changes (step S108: Yes), and goes to step S111 if the new channel assignment information does not change (step S108: No).

In step S110, the system controller notifies the new channel assignment information to the device to be notified, i.e., all the system controllers in the car AV system 1 and the receiving devices, for example, and end this control process.

In step S111, the system controller determines whether or not the device to which the channel assignment information is to be notified is newly added. The system controller goes to step S110 if such an device is newly added (step S111: Yes), and ends this control process if such an device is not added (step S111: No).

According to the channel assignment information generation process shown in FIG. 9, it is possible to generate the channel assignment information in which non-overlapping channels are assigned to the output plugs of all the transmitting device in the car AV system 1.

Next, by referring to the flowchart shown in FIG. 10, the description will be given of the channel assignment information generation process in the case where the system controller stores the existing equipment recognition information.

First, in step S201, the system controller executes the process of obtaining the equipment's own ID of the device which is connected to the bus 10 after the bus reset. In next step S202, the system controller executes the process of comparing the existing equipment recognition information stored in the non-volatile memory with the obtained equipment's own ID. After this, the system controller goes to step S203.

In step S203, the system controller determines, based on the result of the process instep S202, whether or not there exists an device which is not included in the existing equipment recognition information and for which the equipment's own ID is newly recognized (i.e., unrecognized device newly connected to the bus 10), or an device which is included in the existing equipment recognition information but is not included in the obtained equipment's own IDs (i.e., an device which becomes unconnected to the bus 10). The system controller goes to step S204 if it determines that such an device exists (step S203: Yes), and ends this control process if it determines that such an device does not exist (step S203: No).

In step S204, the system controller obtains the equipment information (including the plug type, the number of the plugs) of the unrecognized device, and goes to step S205 after updating the equipment recognition information. In next step S205, the system controller goes to step S206 if the system controller is the representative system controller (step S206: Yes), and stores the obtained equipment recognition information in the non-volatile memory and ends this control process if the system controller is not the representative system controller.

In step S206, the system controller determines whether the transmitting device is included in the unrecognized devices newly connected to the bus 10, or whether or not the transmitting device is included in the devices which become unconnected to the bus 10. If the system controller determines that the transmitting device is included in the unrecognized devices newly connected to the bus 10 or the devices which become unconnected to the bus 10 (step S206: Yes), it goes to step S207. On the contrary, if the system controller determines that the transmitting device is not included in the unrecognized devices newly connected to the bus 10 or the devices which become unconnected to the bus 10 (step S206: No), it goes to step S213. In step S213, the system controller determines, based on the equipment recognition information, whether or not a device to which the channel assignment information is to be notified is newly added. The system controller goes to step S212 if it determines that such a device is newly added (step S213: Yes), and ends this control process if it determines that such a device is not newly added (step S213: No).

In step S207, the system controller determines whether or not it has the existing channel assignment information. The system controller goes to step S208 if it has the existing channel assignment information (step S207: Yes). On the contrary, if the system controller does not have the existing channel assignment information (step S207: No), it goes to step S210 to set the non-overlapping channel to the output plugs of all the transmitting devices in the equipment recognition information thereby to generate the channel assignment information and then goes to step S211.

Instep S208, the system controller refers to the existing channel assignment information, and assigns the channels to the output plugs of the unrecognized transmitting devices newly connected to the bus 10 so as not to overlap with the channels registered in the existing channel assignment information. In next step S209, if necessary, e.g., if the channel assignment information includes information indicating the physical connection state, the system controller updates the connection state information of the transmitting device, whose connection state with the bus 10 changes, in the channel assignment information generated in step S208.

In step S211, the system controller generate new channel assignment information. In next step S212, the system controller notifies the new channel assignment information to the devices to be notified, e.g., all the system controllers in the car AV system 1 and the receiving devices, and then ends this control process.

According to the channel assignment information generation process shown in FIG. 10, it is possible to generate the channel assignment information, in which non-overlapping channels are assigned to the output plugs of all the transmitting devices in the car AV system 1, by assigning the channels only to the unrecognized transmitting devices newly recognized.

In the above embodiment, the representative system controller assigns the channel to the transmitting device which is registered in the existing channel assignment information and which is not connected to the bus 10, and keep it assigned. However, the present invention is not limited to this. If the number of the channel information of the channel assignment information becomes larger than the retainable upper limit number, or if a sufficient time has passed after bus reset, the representative system controller may delete the channel information of the transmitting device unconnected to the bus 10 from the channel assignment information. Alternatively, if the channel assignment information is expressed by the structure as shown in FIG. 7, i.e., if the transmitting device unconnected to the bus 10 is arranged at the last side, the representative system controller may delete the channel assignment information from its last position. Instead, the user may confirm the equipment recognition information by UI and delete the channel information of the transmitting device unconnected to the bus 10 from the channel assignment information. Thereby, more channel information of the transmitting devices connected to the bus 10 may be included in the channel assignment information. Even if the channel information is deleted from the channel assignment information, the representative system controller notifies the channel assignment information to the devices to be notified.

[Method of Notifying Channel Assignment Information to System Controller]

Next, a notifying method of the channel assignment information to the system controller will be described. As described above, the representative system controller notifies the generated channel assignment information to the device to be notified. Here, the device to be notified are all the system controllers and the receiving devices in the car AV system 1.

First, the description will be given of the method by which the representative system controller notifies the channel assignment information to all the system controllers. The reason why the representative system controller notifies the channel assignment information to all the system controllers is that all the system controllers in the car AV system 1 commonly own the generated channel assignment information.

As the concrete notifying method, the representative system controller transmits the channel assignment information to all the system controllers as the channel assignment information setting command.

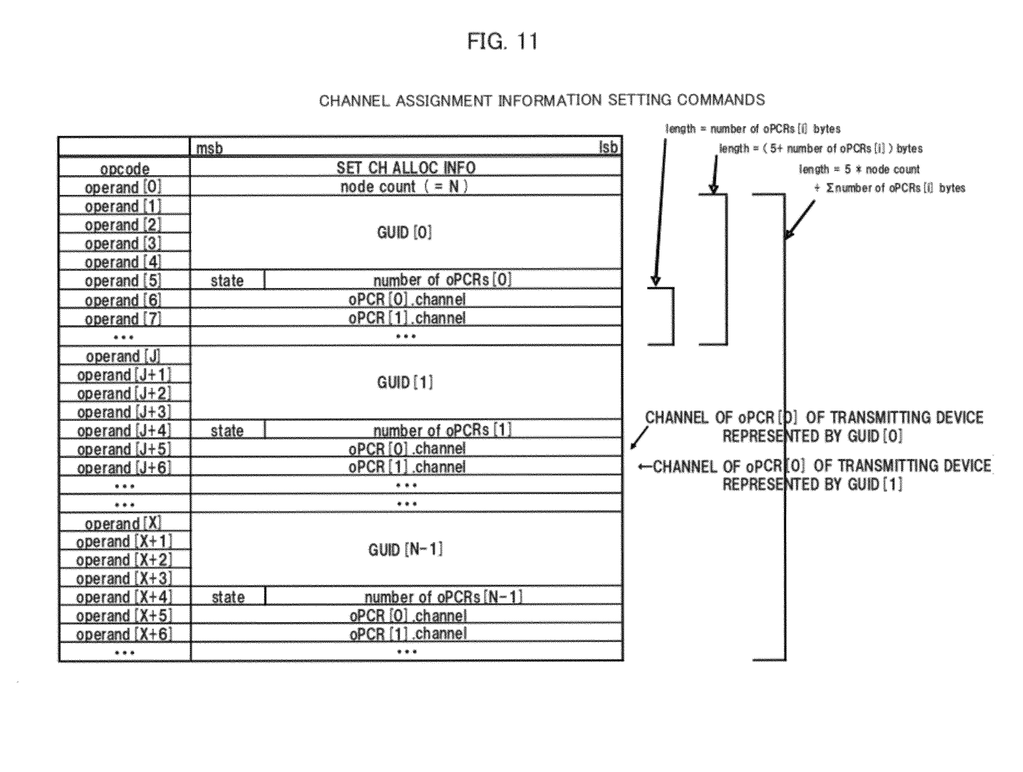

FIG. 11 shows an example of a channel assignment information setting command format. The channel assignment information setting command format shown in FIG. 11 has the channel information of output plugs of X transmitting devices. As shown in FIG. 11, the channel is set to “oPCR[i].channel”. The system controller which receives the channel assignment information stores the received channel assignment information into the non-volatile memory. Here, “all the system controllers” includes the representative system controller itself. However, since the notification to the representative system controller is an internal process, it is needless to say that the representative system controller may internally stores the channel assignment information into the non-volatile memory without notifying it as the command.

By doing as described above, it becomes possible to commonly own the channel assignment information between all the system controllers in the car AV system 1. By this, if the system controller functioning as the representative system controller changes, it is possible to produce new channel assignment information by using the channel assignment information already produced, and it is unnecessary to produce the channel assignment information from the start.

[Connection Establishment Method]

Next, the connection establishment method will be described. Concretely, as the connection establishment method, three method can be conceived according to the specification of the system.

The first connection establishment method will be described. In the first connection establishment method, each of the transmitting devices retains the channel information assigned to the output plugs of the transmitting device, and the device which executes the connection process confirms the channel information retained in the transmitting device subjected to the connection establishment and then establishes the connection.

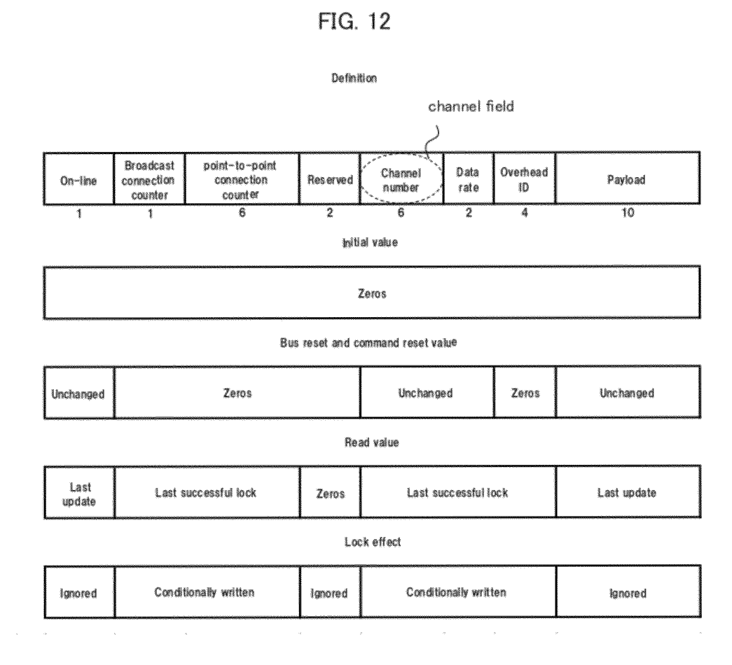

First, the representative system controller refers to the generated channel assignment information, obtains the channel information assigned to the output plugs of each of the transmitting devices, and notifies it to each of the transmitting devices. Concretely, the representative system controller sets the channel information to the channel field of the output plug oPCR of each of the transmitting devices by using the lock transaction defined by IEEE1394. FIG. 12 shows the format of the output plug oPCR defined in IEC61883-1. The representative system controller repeats this operation for all the output plugs of all the transmitting devices. By this, each of the transmitting devices can retain the channels of the output plugs, which are not overlapped with other transmitting device.

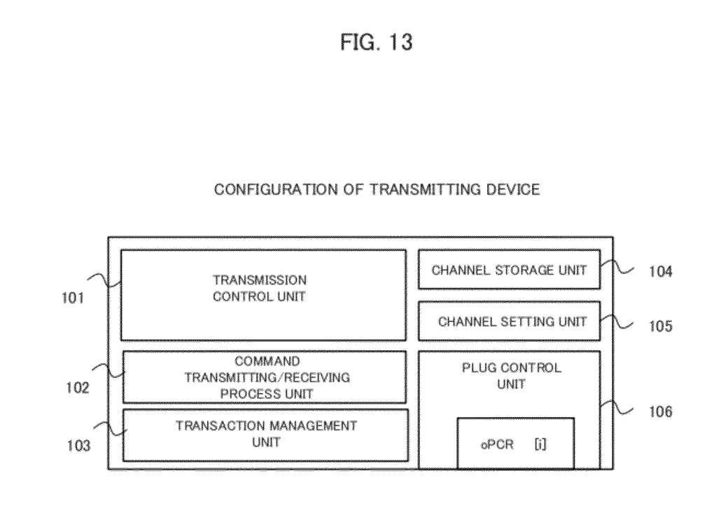

FIG. 13 shows the configuration of the transmitting device in the case where this connection establishment method is used. The transmitting device includes a transmission control unit 101 which performs a data transmission control, a command transmitting/receiving process unit 102 which performs the transmitting/receiving process of the command with other device, a transaction management unit 103 which manages the transaction at the time of the connection process, a channel storage unit 104 which is a non-volatile memory for storing the channel information, a channel setting unit 105 which sets the channel to the output plug oPCR and a plug control unit 106 which performs the control of the output plug.

The channel setting unit 105 stores the channel information that is set to the channel field of the output plug oPCR by the representative system controller into the channel storage unit 104, and resets the channel information stored in the channel storage unit 104 to the channel field of the output plug oPCR.

In this case, the device which executes the connection process (e.g., the receiving device) confirms the channel set to the channel field of the output plug oPCR of the transmitting device, and establishes the connection after acquiring the set channel from the IRM.

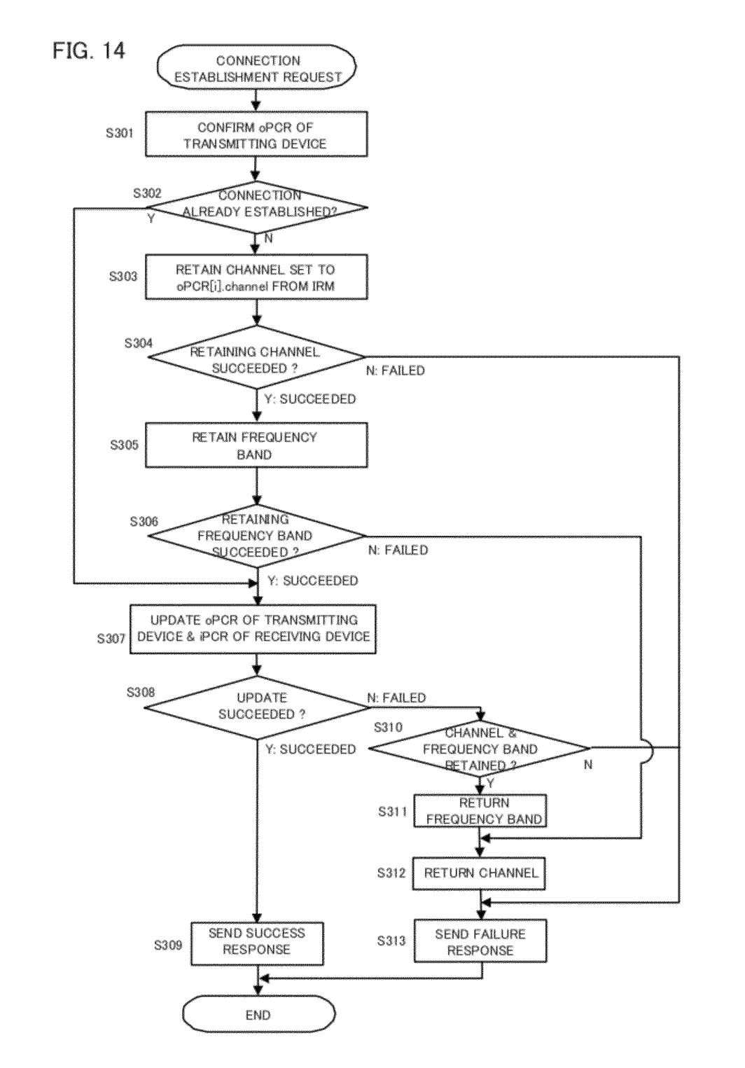

The connection establishment process at this time will be described with referent to the flowchart of FIG. 14.

First, in step S301, the device which executes the connection process receives the connection establishment execution request, and confirms the channel field of the output plug oPCR of the transmitting device. In next step S302, the device which executes the connection determines whether or not the connection has already been established at the output plug of the transmitting device. If it is determined that the connection has already been established (step S302: Yes), the device which executes the connection process goes to step S307 because the channel and the frequency band have already been retained. If it is determined that the connection has not established (step S302: No), the device which executes the connection process goes to step S303. In step S303, the device which executes the connection process executes the process of retaining the channel set to the channel field from the IRM.

In step S304, the device which executes the connection process determines whether or not retaining the channel from the IRM succeeded. The device which executes the connection process goes to step S305 if retaining the channel succeeded (step S304: Yes), and goes to step S313 if retaining the channel did not succeed (step S304: No).

In step S305, the device which executes the connection process executes the process of retaining the frequency band from IRM. In next step S306, the device which executes the connection process determines whether or not retaining the frequency band from the IRM succeeded. The device which executes the connection process goes to step S307 if retaining the frequency band succeeded (step S306: Yes), and goes to step S312 if retaining the frequency band did not succeed (step S306: No).

In step S307, the device which executes the connection process executes the process of updating the output plug oPCR of the transmitting device and the input plug iPCR of the receiving device, i.e., the process of setting the channel to the output plug oPCR of the transmitting device and the input plug iPCR to the receiving device to make the connection state. In next step S308, the device which executes the connection process determines whether or not the updating succeeded. If the updating succeeded (step S308: Yes), the device which executes the connection process goes to step S309 to send the response of success to the connection establishment request, and ends this control process. On the contrary, if the updating did not succeed (step S308: No), the device which executes the connection process goes to step S310 and determines whether or not the channel and the frequency band are retained. In step S310, the device which executes the connection process goes to step S311 if it determines that the channel and the frequency band are retained (step S310: Yes), and goes to step S313 if it determines that the channel and the frequency are not retained (step S310: No). In step S311, the device which executes the connection process returns the frequency band to the IRM. In next step S312, the device which executes the connection process returns the channel to the IRM. Then, the device which executes the connection process goes to step S313. In step S313, the device which executes the connection process sends the response of failure to the connection establishment request, and ends this control process.

According to the connection establishment process given by the flowchart of FIG. 14, the connection can be established if the channel information is retained by the transmitting device itself. As described above, in a general connection establishment process, the device which executes the connection process establishes the connection by referring to the unoccupied channel by the IRM. Therefore, if establishing the connection is tried before all the devices in the car AV system 1 are activated, the channels used for the connection may overlap in the car AV system 1. In contrast, according to the above connection establishment process, the device which executes the connection process uses the non-overlapping channels in the car AV system 1 to establish the connection, and therefore the channels are not overlapped if the connection is established before all the devices in the car AV system 1 are activated. In other words, if the partner of the connection exists on the same bus at the time when the ACC power supply is turned ON, the device which executes the connection process can establish the connection by using the non-overlapping channels in the car AV system 1, without the need of waiting for the activation of all the devices in the car AV system 1.

The second connection establishment method will be described. In the second connection establishment method, the receiving device retains the channel assignment information, and the receiving device refers to the channel assignment information retained by itself to establish the connection with the transmitting device.

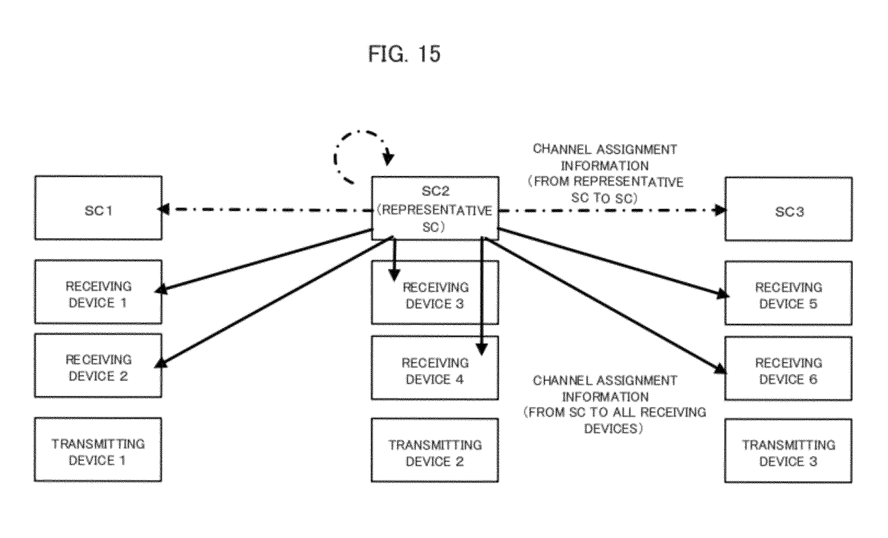

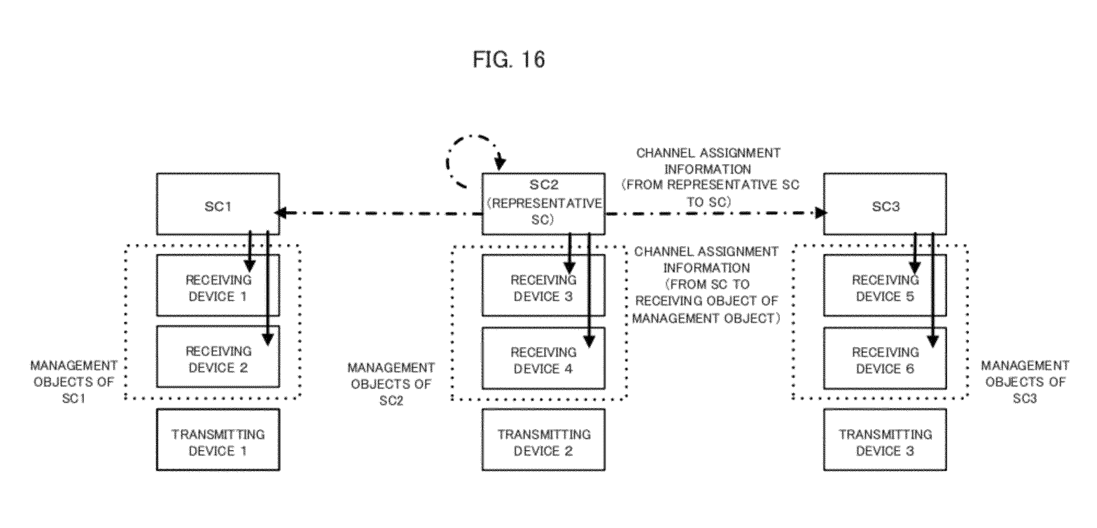

First, the representative system controller notifies the channel assignment information to all the receiving devices, in advance. The method of notifying the channel assignment information to all the receiving devices will be described with reference to FIGS. 15 and 16. FIGS. 15 and 16 are schematic diagrams showing the relationship between the system controllers (SC), the transmitting devices and the receiving devices. In FIGS. 15 and 16, the chain line arrows show the notification from the representative system controller to all the system controllers described above.

Here, there are conceived two methods of notifying the channel assignment information by the representative system controller. The first method is that the representative system controller directly notifies the channel assignment information to all the receiving devices as shown by the solid line arrows. Concretely, the representative system controller transmits the channel assignment information setting command shown in FIG. 11 to all the receiving devices. By this, the channel assignment information can be notifies to all the receiving devices, and each of the receiving devices can retain the channel assignment information. The receiving device which receives the channel assignment information stores the channel assignment information into the non-volatile memory. As shown by the chain line arrows, the representative system controller may omit the notification of the channel assignment information to the receiving device which also functions as the system controller, in order to avoid the redundant notification.

The second method is that each of the system controllers notifies the channel assignment information to the receiving device managed by itself as shown by the solid line arrow of FIG. 16. Concretely, since the channel assignment information is notified from the representative system controller to each of the system controllers, each of the system controllers transmits the channel assignment information setting command shown in FIG. 11 to the receiving device managed by itself as shown by the solid line arrows. By this, the channel assignment information can be notified to all the receiving devices, and each of the receiving devices can retain the channel assignment information. The receiving device which receives the channel assignment information stores the channel assignment information into the non-volatile memory.

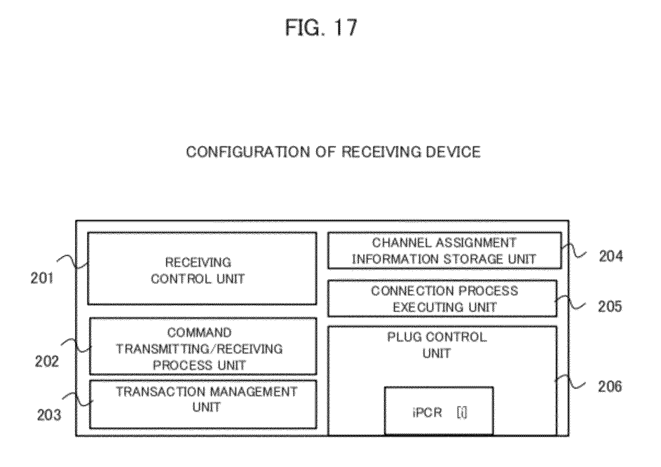

FIG. 17 shows the configuration of the receiving device in the case where this connection establishment method is used. The receiving device includes a receiving control unit 201 which performs the data receiving control, a command transmitting/receiving process unit 202 which performs the transmitting/receiving process of the command with other device, a transaction management unit 203 which manages the transaction at the time of the connection process, a channel assignment information storage unit 204 which is a non-volatile memory storing the channel assignment information, a connection process executing unit 205 which executes the connection processing and a plug control unit 206 which performs the control of the input plug.

The channel assignment information storage unit 204 stores the channel assignment information received from the representative system controller (or the system controller). At the time of establishing the connection, the receiving device refers to the channel assignment information stored in its channel assignment information storage unit 204 to confirm the output plug of the transmitting device subjected to the connection, and retains the channel of the output plug of that transmitting device from the IRM to establish the connection.

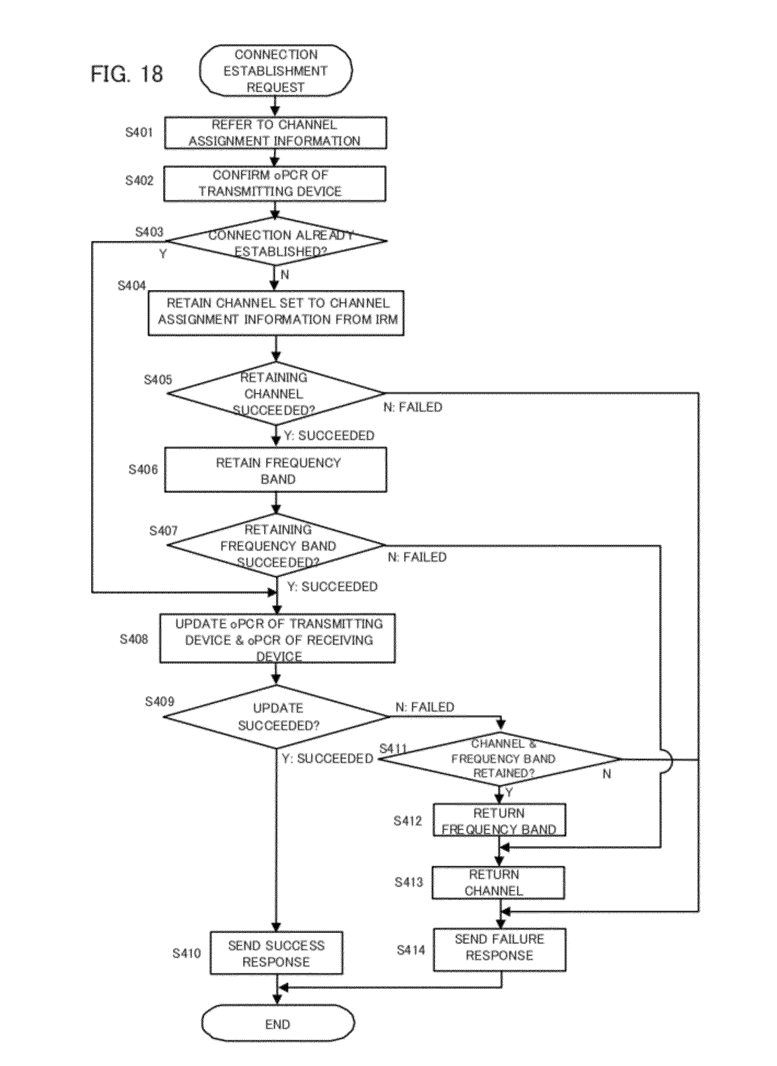

The connection establishment process at this time will be described with reference to the flowchart of FIG. 18.

First, in step S401, the receiving device receives the connection establishment execution request, and refers to the channel assignment information of the designated transmitting device stored in the channel assignment information storage unit. In step S402, the receiving device confirms the output plug of the transmitting device subjected to the connection. In next step S403, the receiving device determines whether or not the connection has established at the output plug of the transmitting device. The receiving device goes to step S408 because the channel and the frequency band are already retained if it determines that the connection has established at the output plug of the transmitting device (step S403: Yes), and goes to step S404 if it determines that the connection has not established at the output plug of the transmitting device (step S403: No). In step S404, the receiving device performs the process of retaining the channel of the output plug of the transmitting device confirmed by the channel assignment information.

In step S405, the receiving device determines whether or not retaining the channel from the IRM is successful. The receiving device goes to step S406 if retaining the channel succeeded (step S405: Yes), and goes to step S414 if retaining the channel does not succeed (step S405: No).

In step S406, the receiving device performs the process of retaining the frequency band from the IRM. In next step S407, the receiving device determines whether or not retaining the frequency band succeeded. The receiving device goes to step S408 if retaining the frequency band succeeded (step S408: Yes), and goes to step S413 if retaining the frequency band does not succeed (step S408: No).

In step S408, the receiving device performs the process of updating the output plug oPCR of the transmitting device and the input plug iPCR of the receiving device. In next step S409, the receiving device determines whether or not updating succeeded. If updating succeeded (step S409: Yes), the receiving device goes to step S410 to send the response of success to the connection establishment request, and ends this control process. On the contrary, if updating is failed (step S409: No), the receiving device goes to step S411, and then determines whether or not the channel and the frequency band are retained. In step S411, the receiving device goes to step S412 if it determines that the channel and the frequency band are retained (step S411: Yes), and goes to step S414 if it determines that the channel and the frequency band are not retained (step S411: No). In step S412, the receiving device returns the frequency band to the IRM. In next step S413, the receiving device returns the channel to the IRM. Thereafter, the receiving device goes to step S414. In step S414, the receiving device sends the response of failure to the connection establishment request, and ends this control process.

According to the connection establishment process shown in FIG. 18, in the case where all the receiving devices retain the channel assignment information, the connection can be established. In addition, also by this connection establishment process, if the partner of the connection exists on the same bus when the ACC power supply is turned ON, the receiving device can establish the connection by using non-overlapping channels in the car AV system 1, without the need of waiting for the activation of all the devices in the car AV system 1.

The third connection establishment method will be described. In the third connection establishment method, the system controller retains the channel assignment information, and does not notify the channel information and the channel assignment information to the transmitting devices and the receiving devices. In this case, the system controller executes the connection process by itself, or the system controller adds the channel information to the connection establishment execution request command and transmits it to the receiving devices and the receiving devices execute the connection process based on the channel information. This will be concretely described below.

First, the description will be given of the connection establishment method in the case where the system controller executes the connection process by itself.

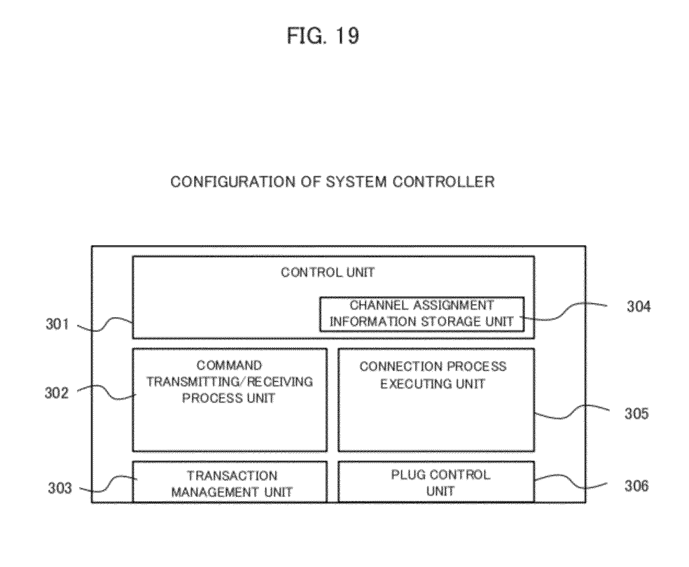

FIG. 19 shows the configuration of the system controller in the case where this connection method is used. The system controller includes a control unit 301 which performs the whole control of the system controller, a command transmitting/receiving process unit 302 which performs the transmitting/receiving process of the command with other device, a transaction management unit 303 which manages the transaction at the time of the connection process, a channel assignment information storage unit 304 such as a non-volatile memory which stores the channel assignment information, a connection process executing unit 305 which executes the connection process and a plug control unit 306 which performs the control of the input/output plug. The plug control unit may be omitted if the system controller itself does not have the input and output plug.

The system controller refers to the channel assignment information stored in the channel assignment information storage unit 304 and performs the connection process between the receiving device under its management and an arbitrary transmitting device, thereby to establish the connection. Concretely, the system controller performs the same process as that the receiving device performs as shown in FIG. 18.

By this, in the case where the system controller has the channel assignment information, the system controller can establish the connection by itself.

Next, the description will be given of the connection establishment method in the case where the channel information is added to the connection establishment execution request command and they are transmitted to the receiving device.

In CCM, there is defined a control command (SIGNAL SOURCE command) which associates an arbitrary source plug, that the AV/C sub-unit existing in the AV/C unit serving as a transmitting device has, with the output plug of the AV/C unit. Also, in CCM, there is defined a control command (INPUT SELECT command) which associates the output plug of the AV/C unit of the transmitting device with the input plug of the AV/C unit of the receiving device and the destination plug of the AV/C sub-unit of the receiving device, thereby to establish the isochronous connection between the output plug of the transmitting device and the input plug of the receiving device and the internal connection between the input plug of the receiving device and the destination plug of the AV/C sub-unit in the receiving device.

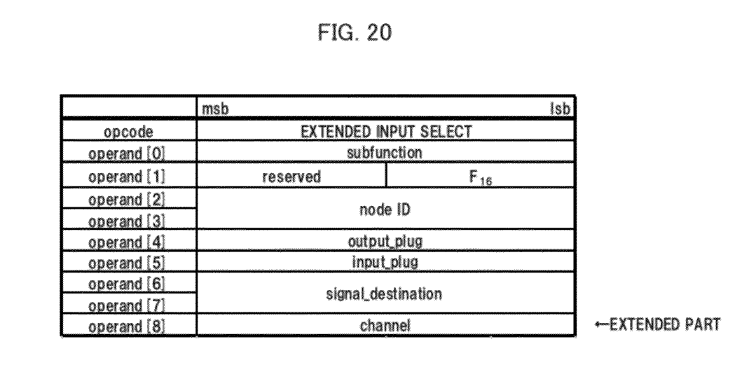

The current definition prescribes to designate the node ID of the transmitting device, the ID of the output plug, the node ID of the receiving device, the AV/C sub-unit of the receiving device and the destination plug of the AV/C sub-unit. Therefore, the system controller expands this connection establishment execution request command to transmit it, with the channel information, at the time of the connection establishment execution request. FIG. 20 shows the format of the expanded INPUT SELECT command. As shown in FIG. 20, in the expanded INPUT SELECT command, the channel field to which the channel information is set is added.

Concretely, at the time of the connection establishment execution request, the system controller refers to the channel assignment information to obtain the channel information of the output plug subjected to the connection, adds the channel information to the connection establishment execution request command and transmits them to the receiving device. The receiving device which received the connection establishment execution request command confirms the added channel information, and establishes the connection after retaining the confirmed channel from the IRM.

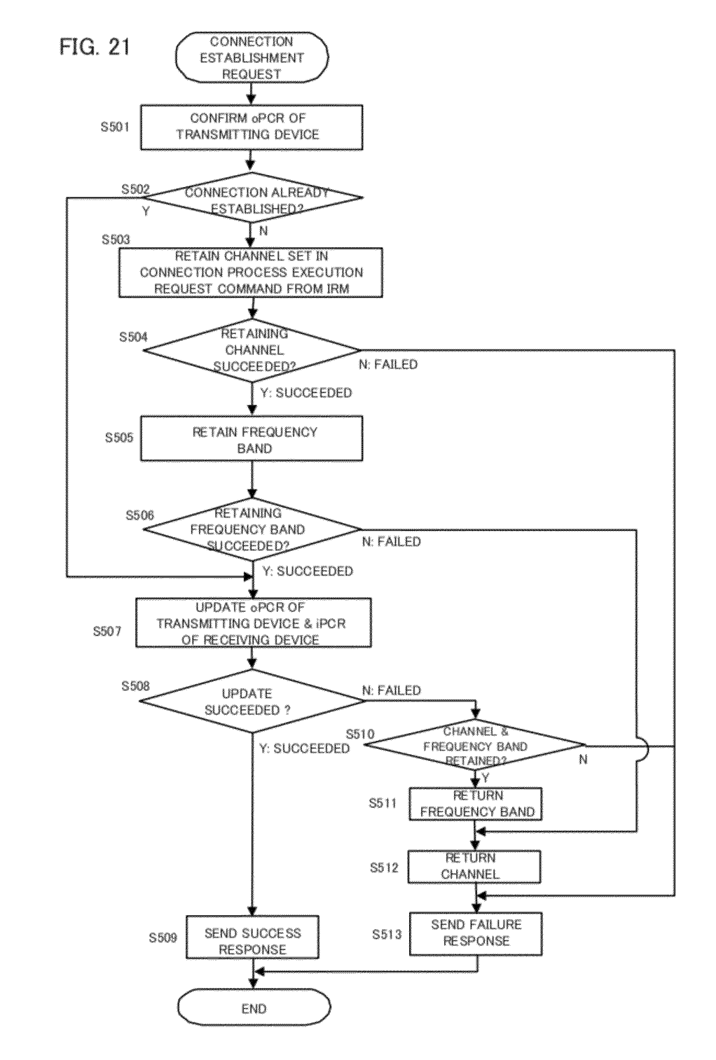

The connection establishment process at this time will be described with reference to FIG. 21.

First, in step S501, the receiving device receives the connection establishment execution request command, and confirms the output plug of the transmitting device. In next step S502, the receiving device determines whether or not the connection has already been established at the output plug of the transmitting device. The receiving device determines that the channel and the frequency band are already retained and goes to step S507 if it determines that the connection has already been established at the output plug of the transmitting device (step S502: Yes), and goes to step S503 if it determines that the connection has not been established (step S502: No). In step S503, the receiving device refers to the connection establishment execution request command to confirm the channel of the output plug of the transmitting device subjected to the connection, and retains the channel of the output plug of the transmitting device confirmed by the channel information in the connection establishment request command from the IRM.

The process of steps S504 to S513 is the same as the process of steps 405 to 414, and hence the description will be omitted.

By this, in the case where the system controller has the channel assignment information, by expanding the connection establishment execution request command, the connection can be established by the receiving device. Also by this connection establishment method, if the partner of the connection exists on the same bus at the time when the ACC power supply is tuned ON, the receiving device can establish the connection by using the non-overlapping channel in the car AV system 1, without the need of waiting for the activation of all the devices in the car AV system 1.

As is understood from the above description, in this embodiment, the channel information in which non-overlapping channels are assigned to the output plugs of the transmitting devices is generated by the representative system controller, and the device which executes the connection process establishes the connection based on the generated channel assignment information. By this, the contention of the channels can be avoided at the time of establishing the connection. Further, by storing the channel assignment information into the non-volatile memory, if the bus 10 is divided when the ACC power supply is turned from OFF to ON, the contention of the channels can be avoided. Further, according to this embodiment, since it is unnecessary to wait for the activation of all the devices after the ACC power supply is turned ON, if the partner of the connection exists on the same bus at the timing when the ACC power supply is turned from OFF to ON, the watching and listening sources before the power off of the ACC power supply can be quickly recovered. Also, the channel assignment information generation method described in this embodiment can flexibly cope with the change of the system configuration such as the addition and/or deletion of the device.

[Modification]

In the above embodiment, non-overlapping channels are assigned to the output plugs of the transmitting devices based on the channel assignment information generated by the representative system controller. However, the present invention is not limited to this. Instead of this, non-overlapping channels within the system may be stored, in advance, in the non-volatile memory of the transmitting device at the time of system configuration stage, and the transmitting device may set the stored channels to the output plugs. Alternatively, non-overlapping channels in the system may be assigned by the user at the time when the transmitting device is set to the system, and the transmitting device may set the channel assigned by the user to the output plug after its activation. The device which executes the connection process (e.g., the receiving device) establishes the connection by performing the same process as is shown in FIG. 14.

By the method of the modification, compared with the method described in the above embodiment, it is not necessary for the representative system controller to generate the channel assignment information, and hence the same result can be obtained with simple method. Namely, the contention of the channels can be avoided at the time of establishing the connection. Also, by storing the channel assignment information in the non-volatile memory, if the bus 10 is divided when the ACC power supply is turned from OFF to ON, the contention of the channels can be avoided at the time of establishing the connection. Also, since it is not necessary to wait for the activation of all the devices after the ACC power supply is turned ON, if the partner of the connection exists on the same bus when the ACC power supply is turned from OFF to ON, the watching and listening sources before the ACC power supply is turned OFF can be quickly recovered.

The present invention is not limited to the above-described embodiment, and can be appropriately modified within a range not departing from the gist and the idea of the invention readable from the claims and the entire specification. The control device, the transmitting device and the receiving device involving such a modification are also included in the technical range of the invention.

### INDUSTRIAL APPLICABILITY

This invention can be used for a network system such as a car AV system using the IEEE1394 bus.

1-15. (canceled)

16. A control device in a network system which establishes a connection, by connecting by a channel corresponding to a frequency band, between a logical output plug of a transmitting device and a logical input plug connected to the transmitting device via a bus, the control device comprising:
an output plug recognizing unit which recognizes the output plugs of all the transmitting devices connected to the bus, after a bus reset, when the bus reset of the bus occurs; and
a channel assignment information generating unit which generates channel assignment information which assigns non-overlapping channels to all the output plugs recognized by the output plug recognizing unit.

17. The control device according to claim 16 further comprising a non-volatile storage unit which stores the channel assignment information generated by the channel assignment information generating unit.

18. The control device according to claim 16, further comprising a channel assignment information notifying unit which transmits the channel assignment information to other control devices in the network system.

19. The control device according to claim 16, further comprising:
a channel information obtaining unit which obtains the channel information of the output plug of the transmitting device based on the channel assignment information; and
a channel information notifying unit which transmits the channel information obtained by the channel information obtaining unit.

20. The control device according to claim 16, further comprising a channel assignment information notifying unit which transmits the channel assignment information to the receiving devices.

21. The control device according to claim 16, further comprising a channel deleting unit which deletes the channel information of the output plug of the transmitting device, which is not connected to the bus, from the channel assignment information, when a number of the channel information of the channel assignment information exceeds a retainable upper limit or a predetermined time passes after the bus reset.

22. The control device according to claim 16, further comprising a non-volatile storage unit which stores the channel assignment information generated by the channel assignment information generating unit,
wherein the channel assignment information generating unit generates the channel assignment information by including the transmitting device, to objects of the channel assignment, which is included in a past channel assignment information but is not recognized by the output plug recognizing unit after the bus reset.

23. A network system which establishes a connection, by connecting by a channel corresponding to a frequency band, between a logical output plug of a transmitting device and a logical input plug connected to the transmitting device via a bus, the network system comprising:
an output plug recognizing unit which recognizes the output plugs of all the transmitting devices connected to the bus, after a bus reset, when the bus reset of the bus occurs; and
a channel assignment information generating unit which generates channel assignment information which assigns non-overlapping channels to all the output plugs recognized by the output plug recognizing unit.

24. The network system according to claim 23, further comprising a non-volatile storage unit which stores the channel assignment information generated by the channel assignment information generating unit,
wherein the channel assignment information generating unit generates the channel assignment information by including the transmitting device, to objects of the channel assignment, which is included in a past channel assignment information but is not recognized by the output plug recognizing unit after the bus reset.

25. A control method executed by a control device in a network system which establishes a connection, by connecting by a channel corresponding to a frequency band, between a logical output plug of a transmitting device and a logical input plug connected to the transmitting device via a bus, the method comprising:
an output plug recognizing process which recognizes the output plugs of all the transmitting devices connected to the bus, after a bus reset, when the bus reset of the bus occurs; and
a channel assignment information generating process which generates channel assignment information which assigns non-overlapping channels to all the output plugs recognized by the output plug recognizing process.

26. The method according to claim 25, further comprising a storing process which stores the channel assignment information generated by the channel assignment information generating unit into a non-volatile storage unit,
wherein the channel assignment information generating process generates the channel assignment information by including the transmitting device, to objects of the channel assignment, which is included in a past channel assignment information but is not recognized by the output plug recognizing unit after the bus process.

27. A control program in a non-transitory storage medium executed by a control device in a network system which establishes a connection, by connecting by a channel corresponding to a frequency band, between a logical output plug of a transmitting device and a logical input plug connected to the transmitting device via a bus, the program makes the control device function as:
an output plug recognizing unit which recognizes the output plugs of all the transmitting devices connected to the bus, after a bus reset, when the bus reset of the bus occurs; and
a channel assignment information generating unit which generates channel assignment information which assigns non-overlapping channels to all the output plugs recognized by the output plug recognizing unit.

28. The control program according to claim 27, further makes the control device function as a storing unit which stores the channel assignment information generated by the channel assignment information generating unit into a non-volatile storage unit,
wherein the channel assignment information generating unit generates the channel assignment information by including the transmitting device, to objects of the channel assignment, which is included in a past channel assignment information but is not recognized by the output plug recognizing unit after the bus reset.
